(19) United States
(12) Patent Application Publication
(10) Pub. No.: US 2025/0311832 A1
(43) Pub. Date: Oct. 9, 2025

(54) SELF-SERVICE NAIL DECORATING METHOD AND NAIL DECORATING MACHINE

(71) Applicant: SHANGHAI MEINAIER TECHNOLOGY CO., LTD., Shanghai (CN)

(72) Inventors: Jin YAN, Shanghai (CN); Xueqian LIU, Shanghai (CN)

(21) Appl. No.: 19/247,006

(22) Filed: Jun. 24, 2025

Related U.S. Application Data
(63) Continuation of application No. PCT/CN2023/079603, filed on Mar. 3, 2023.

(30) Foreign Application Priority Data
Dec. 29, 2022 (CN) 202211707958.5

(51) Int. Cl. A45D 29/00; B41J 3/407; B41J 29/393

(52) U.S. Cl. CPC A45D 29/00; B41J 3/4073; B41J 29/393; A45D 2029/005

(57) ABSTRACT

A self-service nail decorating method and a nail decorating machine are disclosed. The self-service nail decorating method includes: receiving, by a nail decorating machine, a selection signal through a control panel, where a current state of the nail decorating machine being confirmed through the control panel, and generating, by the nail decorating machine, a corresponding feature code and display the feature code through the control panel; performing, by the nail decorating machine, information binding with a mobile terminal through the feature code, such that feedback information is sent to the nail decorating machine by the mobile terminal after the binding is completed; confirming, by the nail decorating machine, a nail decorating process after receiving the feedback information; sending, by the nail decorating machine, a control signal for printing after confirming the step.

### CROSS-REFERENCE TO RELATED APPLICATIONS

The present application is a U.S. Continuation of International Application PCT/CN2023/079603 filed on Mar. 3, 2023, which claims the benefit of and priority to Chinese patent application No. 202211707958.5 filed with China National Intellectual Property Administration on Dec. 29, 2022, the content of the aforementioned applications is incorporated herein by reference in its entirety.

### TECHNICAL FIELD

The present disclosure relates to the field of nail decorating machines, and in particular, to a self-service nail decorating method and a nail decorating machine.

### BACKGROUND

The operation mode of existing nail decorating machines generally requires a user to select a desired spraying shape. The nail decorating machine exports selectable nail decorating shapes for the user from a local storage list, and the user makes a choice according to the mode provided by the nail decorating machine. After the selection is completed, a nail decorating operation is performed. However, the user usually selects a nail decorating machine after completing payment by scanning, the nail decorating machine then starts identification and printing, and the printing is performed finger by finger. If a user needs to spray and print multiple nails of fingers, multiple payment confirmation actions are required, resulting in a cumbersome operation process.

### SUMMARY

The object of the present disclosure is to solve the drawbacks existing in the prior art and provide a self-service nail decorating method and a nail decorating machine.

To achieve the above object, the present disclosure adopts the following technical solution: A self-service nail decorating method including:
S1: receiving, by a nail decorating machine, a selection signal through a control panel, where a current state of the nail decorating machine is confirmed through the control panel, and generating, by the nail decorating machine, a corresponding feature code, and displaying the feature code through the control panel;
S2: performing, by the nail decorating machine, information binding with a mobile terminal through the feature code, such that feedback information is sent to the nail decorating machine by the mobile terminal after the binding is completed;
S3: confirming, by the nail decorating machine, a nail decorating process after receiving the feedback information;
S4: sending, by the nail decorating machine, a control signal for printing after confirming the nail decorating process.

Optionally, the step S1 further includes:
S11: receiving, by the nail decorating machine, a corresponding selection signal through the control panel, where the control panel is provided with a plurality of selection modules corresponding to different selection signals, wherein the control panel sends a detection signal to the nail decorating machine after receiving the selection signal in order to confirm the current state of the nail decorating machine;
S12: generating, by the nail decorating machine, the corresponding feature code according to the current state of the nail decorating machine after receiving the detection signal, and sending the feature code to the control panel;
S13: displaying, by the nail decorating machine, the feature code through the control panel.

Optionally, the step S2 further includes:
S21: sending, by the nail decorating machine, data information to the mobile terminal after receiving a signal, wherein the signal is transmitted to the nail decorating machine by the mobile terminal through scanning or a communication protocol after the feature code is displayed through the control panel;
S22: receiving, by the nail decorating machine, a feedback signal from the mobile terminal, where the feedback signal is sent to the nail decorating machine by the mobile terminal after completing information binding with the nail decorating machine;
S23: displaying, by the nail decorating machine, a required nail decorating process through the control panel after receiving the feedback signal.

Optionally, the step S3 further includes:
S31: displaying, by the nail decorating machine, a plurality of pending nail decorating processes through the control panel, where each of the plurality of pending nail decorating processes is preset with corresponding control information, and the control panel sends the corresponding control information to the nail decorating machine after identifying a selected nail decorating process;
S32: generating, by the nail decorating machine, corresponding control procedure information according to received control information, and displaying the control procedure information through the control panel.

Optionally, the step S4 further includes:

S41: sending, by the nail decorating machine, the received control information to the printing device to control the printing device to perform spray printing in response to a confirmation of the control procedure information on the control panel.

Optionally, the mobile terminal includes a mobile phone, a smart phone, a laptop computer, a tablet, a wearable device, an AR/VR device, a handheld game console, an e-reader, a vehicle-mounted device, or an Internet of Things device.

Optionally, the control panel is provided with a plurality of selection modules for display, the selection modules are a plurality of main modules, and each of the main modules includes a plurality of sub-modules.

Optionally, a state of the nail decorating machine is refreshed at a preset time interval, and each state of the nail decorating machine corresponds to a unique feature code, and the mobile terminal identifies the state of the nail decorating machine through the feature code.

Optionally, the nail decorating process is associated with one of the following: four fingers of the left hand, the thumb of the left hand, four fingers of the right hand, a thumb of the right hand, one or more fingers of five fingers of the left hand, and one or more fingers of five fingers of the right hand.

A nail decorating machine is further provided, applicable to any one of the methods in the above technical solutions, including:
a signal receiving module, configured to receive signals sent by the control panel and the mobile terminal, and send the signals to a control module,
the control module, configured to generate a corresponding control signal after receiving the signals;
a display module, configured to display the feature code and a selection module, and generate control procedure information according to the selection signal and send the control procedure information to the control module;
a signal sending module, configured to send the generated control procedure information to the mobile terminal and send control information to a printing device;
wherein the nail decorating machine is in network connection with a cloud through the signal receiving module to enable real-time updating of a state of the nail decorating machine.

The above technical solutions have the following advantages or beneficial effects:

The connection state of the nail decorating machine can be updated in real time after networking by connecting with the Internet, so that the feature code of the nail decorating machine can be updated and bound to the mobile terminal. By binding with the mobile terminal through the updated feature code, identification can be performed according to the bound feature code when a plurality of mobile terminals are bound, thereby reducing machine errors.

The nail decorating machine can perform self-selection of nail decorating shapes through networking, and can also select designed patterns to spray through data information recorded in the cloud.

The nail decorating processes of the nail decorating machine are optimized, and printing and spraying can be performed respectively on four fingers of the left hand, the thumb of the left hand, four fingers of the right hand, the thumb of the right hand, one or more fingers of the five fingers of the left hand, and one or more fingers of the five fingers of the right hand, thereby improving printing efficiency.

### BRIEF DESCRIPTION OF THE DRAWINGS

FIG. 1 is a flowchart of the nail decorating method provided by the present disclosure;

FIG. 2 is a flowchart of the nail decorating method provided by the present disclosure;

FIG. 3 is a flowchart of the nail decorating method provided by the present disclosure;

FIG. 4 is a flowchart of the nail decorating method provided by the present disclosure;

FIG. 5 is a flowchart of the nail decorating method provided by the present disclosure;

FIG. 6 is a schematic structural diagram of the nail decorating machine provided by the present disclosure.

### REFERENCE NUMERALS

1. Signal receiving module; 2. Control module; 3. Display module; 4. Signal sending module.

### DETAILED DESCRIPTION

The technical solutions in the embodiments of the present disclosure will be clearly and completely described below in conjunction with the drawings in the embodiments of the present disclosure. Obviously, the described embodiments are only a part of the embodiments of the present disclosure, rather than all the embodiments. All other embodiments obtained by those of ordinary skill in the art based on the embodiments of the present disclosure without creative efforts shall fall within the protection scope of the present disclosure.

In the description of the present disclosure, it should be noted that the terms “center”, “upper”, “lower”, “left”, “right”, “vertical”, “horizontal”, “inner”, “outer”, etc. indicate orientations or positional relationships based on the orientations or positional relationships shown in the drawings, and are only for convenience of describing the present disclosure and simplifying the description, rather than indicating or implying that the referred device or element must have a specific orientation, be constructed and operated in a specific orientation, and thus, should not be construed as limiting the present disclosure; the terms “first”, “second”, and “third” are only used for descriptive purposes, and should not be construed as indicating or implying relative importance. In addition, unless otherwise clearly specified and limited, the terms “installation”, “connection”, and “connection” should be understood in a broad sense, for example, it may be a fixed connection, a detachable connection, or an integral connection; it may be a mechanical connection or an electrical connection; it may be a direct connection, or an indirect connection through an intermediate medium, and it may be the internal communication of two elements. For those of ordinary skill in the art, the specific meanings of the above terms in the present disclosure can be understood in specific situations.

The operation mode of existing nail decorating machines generally requires the user to select a desired spraying shape. The nail decorating machine exports selectable nail decorating shapes for the user from a local storage list, and the user makes a choice according to the mode provided by the nail decorating machine. After the selection is completed, a nail decorating operation is performed. However, the user usually selects a nail decorating machine after completing payment by scanning, the nail decorating machine then starts identification and printing, and the printing is performed finger by finger. If a user needs to spray and print multiple nails of fingers, multiple payment confirmation actions are required, resulting in a cumbersome operation process.

The patent with the publication number CN 109495550 B provides a method and device for nail printing. In the patent, a nail decorating machine is connected to a cloud server, so that the nail decorating machine can perform nail printing according to a nail decorating pattern purchased by a user, rather than being limited to print only a limited number of nail decorating patterns stored in itself, thereby better matching the nail decorating needs of the user. In addition, through information feedback between the cloud server and the nail decorating machine, control over each stage in the operation process of the nail decorating machine is realized, and full-process monitoring of the operation process of the nail decorating machine is realized, which is convenient for subsequent large-scale commercial applications. However, when the nail decorating machine is used in large-scale commercial applications, networking conflicts are likely to occur when a plurality of users are connected to the nail decorating machine, ultimately leading to machine connection errors.

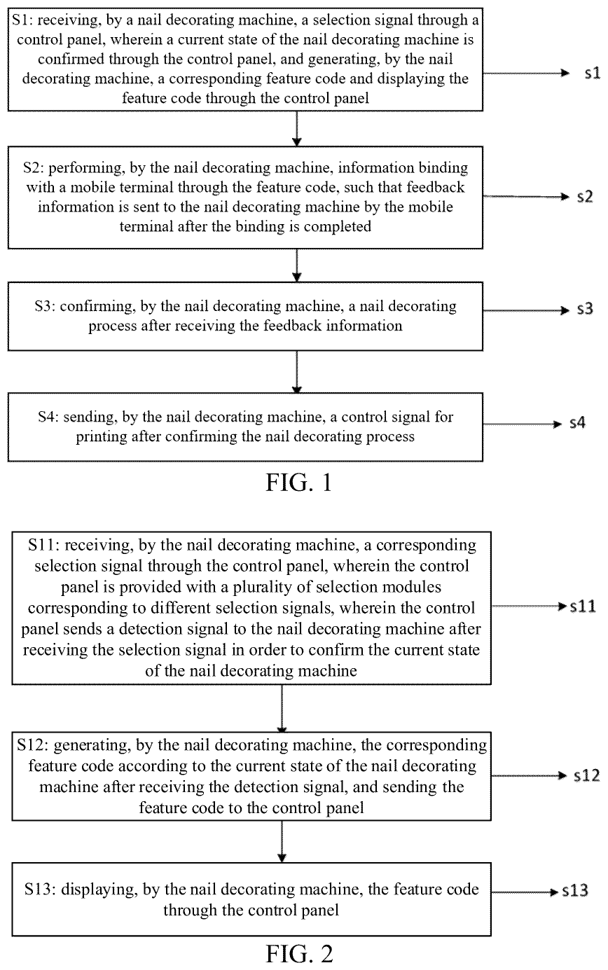

With reference to FIG. 1, in an embodiment provided by the present disclosure, a self-service nail decorating method includes:
S1: receiving, by a nail decorating machine, a selection signal through a control panel, a current state of the nail decorating machine is confirmed through the control panel, and generating, by the nail decorating machine, a corresponding feature code, and displaying the feature code through the control panel;
S2: performing, by the nail decorating machine, information binding with a mobile terminal through the feature code, such that feedback information is sent to the nail decorating machine by the mobile terminal after the binding is completed;
S3: confirming, by the nail decorating machine, a nail decorating process after receiving the feedback information;
S4: sending, by the nail decorating machine, a control signal for printing after confirming the nail decorating process.

In this embodiment, the nail decorating machine receives an external selection signal through the control panel for selection. At the same time, the control panel confirms the current state of the nail decorating machine and generates a corresponding feature code, which is displayed through the control panel. The mobile terminal identifies the feature code and binds to the nail decorating machine in the current state. After the binding is completed, data information is sent to the mobile terminal for confirmation. After the user confirms through the mobile terminal, relevant data is transmitted to the nail decorating machine, and the nail decorating machine controls the printing device to print according to the received selection signal.

In some embodiments, in step S2, the confirmation of the mobile terminal may not be required.

With reference to FIG. 2, specifically, step S1 further includes:
S11: receiving, by the nail decorating machine, a corresponding selection signal through the control panel, where the control panel is provided with a plurality of selection modules corresponding to different selection signals, where the control panel sends a detection signal to the nail decorating machine after receiving the selection signal in order to confirm the current state of the nail decorating machine;
S12: generating, by the nail decorating machine, the corresponding feature code according to the current state of the nail decorating machine after receiving the detection signal, and sending the feature code to the control panel;
S13: displaying, by the nail decorating machine, the feature code through the control panel.

In this embodiment, the nail decorating machine receives a selection signal through the control panel. The control panel is provided with a plurality of selection modules, including a preselection module and a Do-It-Yourself (DIY) module. The preselection module includes a preset style storage module and a preset style display module. The DIY module includes a palm model display module, a DIY material storage module, a DIY material upload module, a DIY style design module, a DIY style storage module, and a DIY style display module. A user can select a locally designed style from the preselection module according to his or her needs, or select the DIY module to design a nail decorating style according to his or her preferences. When selecting a corresponding module, the selected module sends a corresponding selection signal to the control panel. After receiving the selection signal, the control panel sends a detection signal to the nail decorating machine to confirm the current state of the nail decorating machine to determine whether the nail decorating machine is currently in a operation state. If yes, a prompt to wait is given; if no, a corresponding feature code is generated according to the current state of the nail decorating machine and sent to the control panel, and after receiving the feature code, the control panel displays the feature code.

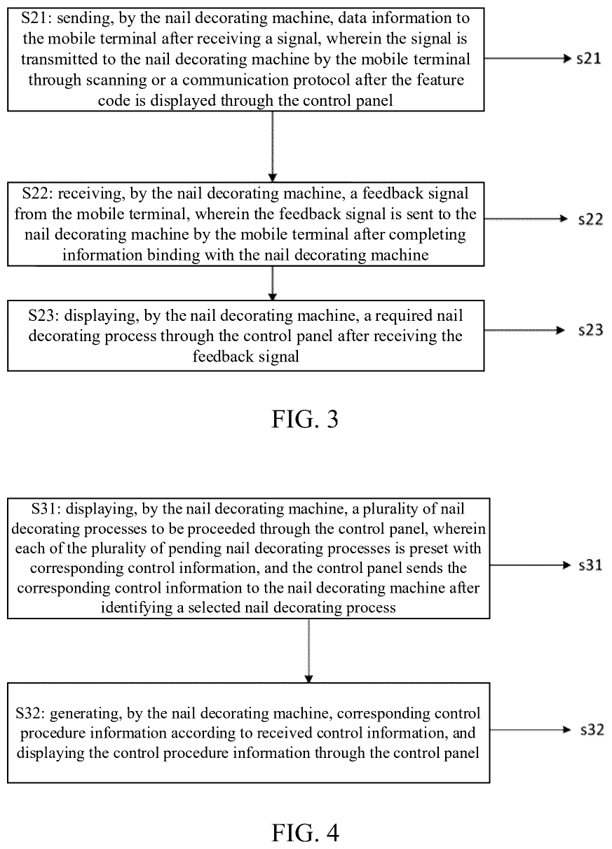

With reference to FIG. 3, step S2 further includes:
S21: sending, by the nail decorating machine, data information to the mobile terminal after receiving a signal, where the signal is transmitted to the nail decorating machine by the mobile terminal through scanning or a communication protocol after the feature code is displayed through the control panel;
S22: receiving, by the nail decorating machine, a feedback signal from the mobile terminal, where the feedback signal is sent to the nail decorating machine by the mobile terminal after completing information binding with the nail decorating machine;
S23: displaying, by the nail decorating machine, a required nail decorating process through the control panel after receiving the feedback signal.

In this embodiment, after the feature code is displayed through the control panel, the mobile terminal can be adapted to the nail decorating machine through signal transmission of scanning or wireless connection. After receiving the connection signal, the nail decorating machine sends data information to the mobile terminal to complete the binding of the nail decorating machine and the mobile terminal for network connection, so that the data selected by the nail decorating machine can be compared with the control panel.

In some embodiments, in step S22, the confirmation of the mobile terminal may not be required, that is, the mobile terminal completes information binding with the nail decorating machine when receiving the data information, and then sends a feedback signal to the nail decorating machine.

With reference to FIG. 4, step S3 further includes:
S31: displaying, by the nail decorating machine, a plurality of pending nail decorating processes through the control panel, where each of the plurality of nail decorating processes is preset with corresponding control information, and the control panel sends the corresponding control information to the nail decorating machine after identifying a selected nail decorating process;
S32: generating, by the nail decorating machine, corresponding control procedure information according to received control information, and displaying the control procedure information through the control panel.

In this embodiment, the nail decorating machine displays a plurality of pending nail decorating processes through the control panel. Each nail decorating process is provided with corresponding control information. After the control panel identifies the selected nail decorating process, corresponding control procedure information is generated according to the different order of the received control information and sent to the mobile terminal. The generated control procedure information can independently select a finger part to be decorated according to user needs. The control procedure information is displayed through the control panel for the user to confirm before starting the nail decoration.

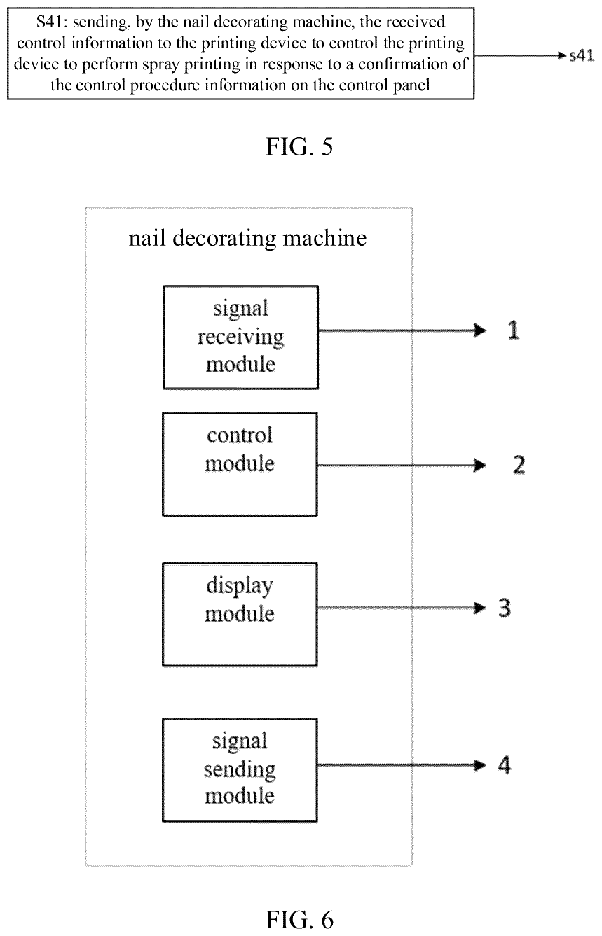

With reference to FIG. 5, step S4t further includes:
S41: sending, by the nail decorating machine, the received control information to the printing device to control the printing device to perform spray printing in response to a confirmation of the control procedure information on the control panel.

In this embodiment, after receiving the confirmation on the control panel from the user, the nail decorating machine sends the received control information to the printing device, and the printing device performs spray printing on the nail below according to the received control information.

Specifically, the control panel is provided with a plurality of selection modules for display. The selection modules are a plurality of main modules, and each main module includes a plurality of sub-modules; the mobile terminal includes a mobile phone, a smart phone, a laptop computer, a tablet, a wearable device, an AR/VR device, a handheld game console, an e-reader, a vehicle-mounted device, an Internet of Things device, etc., and the present disclosure does not impose any restrictions thereon.

In this embodiment, a touch screen is connected to the outside of the control panel, and selection can be performed through the touch screen, or auxiliary connection can be performed through a communication protocol such as Bluetooth. Through the connection of the mobile terminal, display is performed on the touch screen of the nail decorating machine. After the display is completed, a nail decorating mode to be performed is selected through the touch screen. The main modules are a pre-selection module and a DIY module, which have a plurality of sub-modules inside.

The state of the nail decorating machine can be refreshed at a preset time interval, and each state of the nail decorating machine corresponds to a feature code of the state, and the mobile terminal can determine the state of the nail decorating machine through the feature code. The pre-selection module includes a preset style storage module and a preset style display module, and the DIY module includes a palm model display module, a DIY material storage module, a DIY material upload module, a DIY style design module, a DIY style storage module, and a DIY style display module.

The nail decorating process can be associated with one of the following: four fingers of the left hand, the thumb of the left hand, four fingers of the right hand, the thumb of the right hand, one or more fingers of the five fingers of the left hand, and one or more fingers of the five fingers of the right hand, so that control procedure information of the printing device is determined by selecting the nail decorating process.

In this embodiment, the main steps of the nail decorating machine are four steps including four fingers of the left hand, the thumb of the left hand, four fingers of the right hand, and the thumb of the right hand. Because the inclination angles of the thumb and the other four fingers are different, the printing step to be performed is selected through the control panel, and corresponding control procedure information is generated at the same time, and the printing device is controlled to print through the generated control procedure information.

With reference to FIG. 6, an embodiment of a nail decorating machine is provided by the technical solution of the present disclosure. The nail decorating machine is applicable to any one of the above methods, and includes:
a signal receiving module 1, configured to receive signals sent by the control panel and the mobile terminal, and send the signals to the control module 2,
a control module 2, configured to generate a corresponding control signal after receiving the signals;
a display module 3, configured to display the feature code and the selection module, and generate control procedure information according to the selection signal and send the control procedure information to the control module 2;
a signal sending module 4, configured to send the generated control procedure information to the mobile terminal and send control information to the printing device;
where the nail decorating machine may perform networking with the cloud through the signal receiving module 1 to enable updating of the state of the nail decorating machine in real time.

The nail decorating machine of the present disclosure includes the above multiple modules, and the exemplary implementation manners of these modules are as follows. The signal receiving module 1 can adopt existing communication technologies, such as Wi-Fi, Bluetooth, or a wired communication interface, etc., to receive signals from the control panel and the mobile terminal. The control panel and the mobile terminal send signals to the signal receiving module through these communication technologies. After receiving the signals, the signal receiving module converts them into a format suitable for transmission, and sends the signals to the control module 2 through an internal communication line or interface. For example, the signal receiving module may include a Wi-Fi chip and a corresponding antenna, which are used to receive signals sent by the control panel and the mobile terminal through Wi-Fi, then decode and process the received signals, and send them to the control module through an internal bus. The control module 2 is the core control unit of the nail decorating machine, and can be implemented by a microprocessor, a microcontroller, or an application-specific integrated circuit (ASIC), etc. When the control module receives the signals sent by the signal receiving module, the control module will analyze and process the signals according to the preset program logic and algorithm, and generate a corresponding control signal. For example, the control module can determine the nail decorating process and mode selected by the user according to the received selection signal, and then generate a corresponding control signal to control other components of the nail decorating machine to perform corresponding operations. The control module can also monitor and manage the operating state of the nail decorating machine, such as monitoring parameters such as the temperature and pressure of the nail decorating machine, to ensure the normal operation of the nail decorating machine. The display module 3 can be implemented by a liquid crystal display (LCD), a light-emitting diode display (LED), or other types of display technologies. This module is used to display the feature code and the selection module, and the user can see the current state of the nail decorating machine and the available nail decorating processes and other information through the display module. When the control panel receives the selection signal, the display module will display the corresponding control procedure information according to the instruction of the control module. For example, the display module can display a graphical interface, the user can select the nail decorating process by touching the screen or buttons, and the display module will display the selection of the user and corresponding control procedure information in real time. The signal sending module 4 can also adopt existing communication technologies, such as Wi-Fi, Bluetooth, or a wired communication interface, etc., to send the generated control procedure information to the mobile terminal and send the control information to the printing device. For example, the signal sending module may include a Bluetooth chip and a corresponding antenna, which are used to send the control procedure information to the mobile terminal through Bluetooth, and send the control information to the printing device through a wired communication interface. The signal sending module can encode and modulate signals according to different communication protocols and interface standards to ensure the reliable transmission of the signals. The nail decorating machine may also be in network connection with the cloud through the signal receiving module 1, which may be realized through the existing network communication technology, such as connecting to the Internet through Wi-Fi or a wired network to communicating with the cloud server. The cloud server can store data such as the state information of the nail decorating machine, the nail decorating records of the user, and the nail decorating pattern library. The nail decorating machine can realize real-time updating of its own state information through the connection with the cloud, such as obtaining the latest nail decorating patterns, updating the software version, etc. For example, the nail decorating machine can regularly send a status report to the cloud, and the cloud analyzes and evaluates the status of the nail decorating machine according to these reports, and sends the relevant update information to the nail decorating machine. The above implementation manners of the various modules are only exemplary descriptions of the present disclosure, and are not limitations of the present disclosure. Those skilled in the art can carry out appropriate design and optimization on these modules according to actual needs and application scenarios, so as to realize the technical solution of the present disclosure.

In the embodiment, the nail decorating machine receives the selection signal sent by the control panel through the signal receiving module 1. After receiving the selection signal, the control panel sends a detection signal to the nail decorating machine. After the nail decorating machine receives the detection signal through the signal receiving module 1, the control module 2 confirms the state of the nail decorating machine, communicates with the nail decorating machine through the cloud, determines a current state of the nail decorating machine, generates a corresponding feature code according to the current state, and displays the feature code through the display module 3.

When the mobile terminal calls the payment interface for payment, the mobile terminal scans the feature code or performs wireless connection pairing. The user uses the mobile phone camera to scan the feature code for binding through the scan button on the valid order page after successful payment. After the binding is completed, the subsequent nail decorating processes are confirmed and selected through the touch screen. The mobile terminal transmits corresponding signals to the nail decorating machine through scanning or a communication protocol. After receiving the signals, the nail decorating machine sends data information to the mobile terminal through the signal sending module 4. The nail decorating machine divides the entire nail decorating process into four steps, and the cloud records the uncompleted steps. At the end of each step, an unstarted nail decorating process can be arbitrarily selected. When all the four steps are completed, the entire order is regarded as completed. The nail decorating machine generates corresponding control procedure information according to the received control information and sends the control procedure information to the mobile terminal for confirmation. After the mobile terminal confirms, the mobile terminal sends a confirmation signal to the nail decorating machine. After receiving the confirmation signal, the nail decorating machine performs printing control according to the control procedure information.

Finally, it should be noted that the above descriptions are only preferred embodiments of the present disclosure and are not intended to limit the present disclosure. Although the present disclosure has been described in detail with reference to the foregoing embodiments, for those skilled in the art, it is still possible to modify the technical solutions described in the foregoing embodiments, or perform equivalent replacement on some of the technical features. Any modification, equivalent replacement, improvement, etc. made within the spirit and principle of the present disclosure shall be included in the protection scope of the present disclosure.

What is claimed is:

1. A self-service nail decorating method, comprising following steps:
S1: receiving, by a nail decorating machine, a selection signal through a control panel, wherein a current state of the nail decorating machine is confirmed through the control panel, and generating, by the nail decorating machine, a corresponding feature code and displaying the feature code through the control panel;
S2: performing, by the nail decorating machine, information binding with a mobile terminal through the feature code, such that feedback information is sent to the nail decorating machine by the mobile terminal after the binding is completed;
S3: confirming, by the nail decorating machine, a nail decorating process after receiving the feedback information; and
S4: sending, by the nail decorating machine, a control signal for printing after confirming the nail decorating process.

2. The self-service nail decorating method according to claim 1, wherein the step S1 further comprises:
S11: receiving, by the nail decorating machine, a corresponding selection signal through the control panel, wherein the control panel is provided with a plurality of selection modules corresponding to different selection signals, wherein the control panel sends a detection signal to the nail decorating machine after receiving the selection signal in order to confirm the current state of the nail decorating machine; and
S12: generating, by the nail decorating machine, the corresponding feature code according to the current state of the nail decorating machine after receiving the detection signal, and sending the feature code to the control panel;
S13: displaying, by the nail decorating machine, the feature code through the control panel.

3. The self-service nail decorating method according to claim 1, wherein the step S2 further comprises:
S21: sending, by the nail decorating machine, data information to the mobile terminal after receiving a signal, wherein the signal is transmitted to the nail decorating machine by the mobile terminal through scanning or a communication protocol after the feature code is displayed through the control panel;
S22: receiving, by the nail decorating machine, a feedback signal from the mobile terminal, wherein the feedback signal is sent to the nail decorating machine by the mobile terminal after completing information binding with the nail decorating machine; and
S23: displaying, by the nail decorating machine, a required nail decorating process through the control panel after receiving the feedback signal.

4. The self-service nail decorating method according to claim 1, wherein the step S3 further comprises:
S31: displaying, by the nail decorating machine, a plurality of nail decorating processes to be proceeded through the control panel, wherein each of the plurality of pending nail decorating processes is preset with corresponding control information, and the control panel sends the corresponding control information to the nail decorating machine after identifying a selected nail decorating process;
S32: generating, by the nail decorating machine, corresponding control procedure information according to received control information, and displaying the control procedure information through the control panel.

5. The self-service nail decorating method according to claim 4, wherein the step S4 further comprises:
S41: sending, by the nail decorating machine, the received control information to the printing device to control the printing device to perform spray printing in response to a confirmation of the control procedure information on the control panel.

6. The self-service nail decorating method according to claim 1, wherein the mobile terminal comprises a mobile phone, a smart phone, a laptop computer, a tablet, a wearable device, an AR/VR device, a handheld game console, an e-reader, a vehicle-mounted device, or an Internet of Things device.

7. The self-service nail decorating method according to claim 1, wherein the control panel is provided with a plurality of selection modules for display, the selection modules are a plurality of main modules, and each of the main modules comprises a plurality of sub-modules.

8. The self-service nail decorating method according to claim 1, wherein a state of the nail decorating machine is refreshed at a preset time interval, and each state of the nail decorating machine corresponds to a unique feature code, and the mobile terminal identifies the state of the nail decorating machine through the feature code.

9. The self-service nail decorating method according to claim 1, wherein the nail decorating process is associated with one of the following: four fingers of a left hand, a thumb of the left hand, four fingers of a right hand, a thumb of the right hand, one or more fingers of five fingers of the left hand, and one or more fingers of five fingers of the right hand.

10. A nail decorating machine, applicable to the method of claim 1, comprising:
a signal receiving module (1), configured to receive signals sent by the control panel and the mobile terminal, and send the signals to a control module (2),
the control module (2), configured to generate a corresponding control signal after receiving the signals;
a display module (3), configured to display the feature code and a selection module, and generate control procedure information according to the selection signal and send the control procedure information to the control module (2);
a signal sending module (4), configured to send the generated control procedure information to the mobile terminal and send control information to a printing device;
wherein the nail decorating machine is in network connection with a cloud through the signal receiving module (1) to enable real-time updating of a state of the nail decorating machine.
